(19) United States
(12) Patent Application Publication
(10) Pub. No.: US 2017/0198114 A1
(43) Pub. Date: Jul. 13, 2017

(54) AIRCRAFT TIRE

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: José Carlos ARAUJO DA SILVA, Clermont-Ferrand Cedex 9 (FR); Mathilde ABAD, Clermont-Ferrand Cedex 9 (FR); Aurélie TRIGUEL, Clermont-Ferrand Cedex 9 (FR)

(21) Appl. No.: 15/327,958

(22) PCT Filed: Jul. 9, 2015
(86) PCT No.: PCT/EP2015/065757

§ 371 Date: Jan. 20, 2017

(30) Foreign Application Priority Data
Jul. 22, 2014 (FR) 1457054

(51) Int. Cl. C08K 3/06; C08L 23/08; C08L 23/16; C08K 3/04

(52) U.S. Cl. CPC C08K 3/06; C08K 3/04; C08L 23/083; C08L 23/16; C08L 2205/02

(57) ABSTRACT

The present invention relates to an aircraft tire, the tread of which comprises a rubber composition based on at least one first diene elastomer, a reinforcing filler and a crosslinking system, which first diene elastomer comprises ethylene units and diene units comprising a carbon-carbon double bond, which units are distributed randomly within the first diene elastomer, the ethylene units representing at least 50 mol % of the combined monomer units of the first diene elastomer. Such a tire exhibits a performance on landing which is greatly improved, in particular with regard to the wear resistance at very high speeds.

This application is a 371 national phase entry of PCT/EP2015/065757, filed 9 Jul. 2015, which claims benefit of French Patent Application No. 1457054, filed 22 Jul. 2014, the entire contents of which are incorporated herein by reference for all purposes.

### BACKGROUND

1. Technical Field

The present invention relates to tires intended to equip aircraft.

2. Related Art

In a known way, an aircraft tire has to withstand elevated conditions of pressure, load and speed. Furthermore, it also has to satisfy requirements of wear resistance and of endurance. Endurance is understood to mean the ability of the tire to withstand, over time, the cyclical stresses to which it is subjected. When the tread of an aircraft tire is worn, which marks the end of a first serviceable life, the tire is retreaded, that is to say that the worn tread is replaced by a new tread in order to make possible a second serviceable life. An improved wear resistance makes it possible to carry out a greater number of landings per serviceable life An improved endurance makes it possible to increase the number of serviceable lives of one and the same tire.

It is known to use, in aircraft tire treads, rubber compositions based on natural rubber and on carbon black, these two main elements making it possible to obtain compositions having properties compatible with the conditions of use of an aircraft tire. In addition to these main elements, these compositions comprise the normal additives for compositions of this type, such as a vulcanization system and protective agents.

Such aircraft tire tread compositions have been used for many years and exhibit mechanical properties which allow them to withstand the very specific conditions of wear of aircraft tires. This is because these tires are subjected to very large variations in temperature and in speed, in particular on landing, where they have to change from a zero speed to a very high speed, bringing about considerable heating and considerable wear.

It is thus always advantageous for aircraft tire manufacturers to find more effective and more resistant solutions, in particular solutions which are more resistant to the extreme conditions of wear generated during the landing of aircraft. One study (S. K. Clark, “Touchdown dynamics”, Precision Measurement Company, Ann Arbor, Mich., NASA, Langley Research Center, Computational Modeling of Tires, pages 9-19, published in August 1995) has described the stresses to which aircraft tires are subjected on landing and has provided a method for the evaluation of the performances of aircraft tires during these stresses.

During their research studies, the Applicant Companies have found that a specific composition of aircraft tire treads could improve the properties of aircraft tires, in particular for the landing phase of these tires.

### SUMMARY

Consequently, the invention relates to an aircraft tire, the tread of which comprises a rubber composition based on at least one first diene elastomer, a reinforcing filler and a crosslinking system, which first diene elastomer comprises ethylene units and diene units comprising a carbon-carbon double bond, which units are distributed randomly within the first diene elastomer, the ethylene units representing at least 50 mol % of the combined monomer units of the first diene elastomer.

### I. DETAILED DESCRIPTION OF EXAMPLE EMBODIMENTS

The expression composition “based on” should be understood as meaning a composition comprising the mixture and/or the reaction product of the various constituents used, some of these base constituents being capable of reacting, or intended to react, with one another, at least in part, during the various phases of manufacture of the composition, in particular during the crosslinking or vulcanization thereof.

The expression “part by weight per hundred parts by weight of elastomer” (or phr) should be understood as meaning, within the meaning of embodiments of the present invention, the portion by weight per hundred parts of elastomer.

In the present description, unless expressly indicated otherwise, all the percentages (%) shown are percentages (%) by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

Generally, a tire comprises a tread intended to come into contact with the ground via a running surface and connected via two sidewalls to two beads, the two beads being intended to provide a mechanical connection between the tire and the rim on which the tire is fitted.

In that which follows, the circumferential, axial and radial directions respectively denote a direction tangential to the running surface of the tire along the direction of rotation of the tire, a direction parallel to the axis of rotation of the tire and a direction perpendicular to the axis of rotation of the tire. “Radially internal or respectively radially external” is understood to mean “closer to or respectively further away from the axis of rotation of the tire”. “Axially internal or respectively axially external” is understood to mean “closer to or respectively further away from the equatorial plane of the tire”, the equatorial plane of the tire being the plane which passes through the middle of the running surface of the tire and is perpendicular to the axis of rotation of the tire.

A radial tire more particularly comprises a reinforcement comprising a crown reinforcement radially internal to the tread and a carcass reinforcement radially internal to the crown reinforcement.

The carcass reinforcement of an aircraft tire generally comprises a plurality of carcass layers extending between the two beads and divided between a first and a second family.

The first family consists of carcass layers which are wound, in each bead, from the inside towards the outside of the tire, around a circumferential reinforcing element, known as bead thread, in order to form a turn-up, the end of which is generally radially external to the radially outermost point of the bead thread. The turn-up is the carcass layer portion between the radially innermost point of the carcass layer and its end. The carcass layers of the first family are the closest carcass layers to the internal cavity of the tire and thus the axially innermost, in the sidewalls.

The second family consists of carcass layers which extend, in each bead, from the outside towards the inside of the tire, as far as an end which is generally radially internal to the radially outermost point of the bead thread. The carcass layers of the second family are the closest carcass layers to the external surface of the tire and thus the axially outermost, in the sidewalls.

Usually, the carcass layers of the second family are positioned, over their entire length, outside the carcass layers of the first family, that is to say that they cover, in particular, the turn-ups of the carcass layers of the first family. Each carcass layer of the first and of the second family consists of reinforcing elements which are parallel to one another, forming, with the circumferential direction, an angle of between 80° and 100°.

The reinforcing elements of the carcass layers are generally cords consisting of spun textile filaments, preferably made of aliphatic polyamide or of aromatic polyamide, and characterized by their mechanical properties in extension. The textile reinforcing elements are subjected to tension over an initial length of 400 mm at a nominal rate of 200 mm/min. All the results are a mean of 10 measurements.

In use, an aircraft tire is subjected to a combination of load and of pressure inducing a high degree of bending, typically of greater than 30% (for example than 32% or 35%). The degree of bending of a tyre is, by definition, its radial deformation, or its variation in radial height, when the tire changes from an unladen inflated state to an inflated state laden statically, under pressure and load conditions as defined, for example, by the standard of the Tyre and Rim Association or TRA. It is defined by the ratio of the variation in the radial height of the tire to half the difference between the external diameter of the tire, measured under static conditions in an unladen state inflated to the reference pressure, and the maximum diameter of the rim, measured on the rim flange. The TRA standard defines in particular the squashing of an aircraft tire by its squashed radius, that is to say by the distance between the axis of the wheel of the tire and the plane of the ground with which the tire is in contact under the reference pressure and load conditions.

An aircraft tire is furthermore subjected to a high inflation pressure, typically of greater than 9 bar. This high pressure level implies a large number of carcass layers, as the carcass reinforcement is proportioned in order to ensure the resistance of the tire to this pressure level with a high safety factor. By way of example, the carcass reinforcement of a tire, the operating pressure of which, as recommended by the TRA standard, is equal to 15 bar, has to be proportioned to resist a pressure equal to 60 bar, assuming a safety factor equal to 4. With the textile materials commonly used for the reinforcing elements, such as aliphatic polyamides or aromatic polyamides, the carcass reinforcement can, for example, comprise at least 5 carcass layers.

In use, the running mechanical stresses induce bending cycles in the beads of the tire, which are wound around the rim flanges. These bending cycles generate in particular, in the portions of the carcass layers located in the region of bending on the rim, variations in curvature combined with variations in elongation of the reinforcing elements of the carcass layers. These variations in elongation or deformations, in particular in the axially outermost carcass layers, can have negative minimum values, corresponding to being placed in compression. This placing in compression is capable of inducing fatigue failure of the reinforcing elements and thus a premature degradation of the tire.

Thus, the aircraft tire according to embodiments of the invention is preferably an aircraft tire which is subjected, during its use, to a combination of load and of pressure inducing a degree of bending of greater than 30.

Likewise, the aircraft tire according to embodiments of the invention is preferably an aircraft tire comprising, in addition to the tread, an internal structure comprising a plurality of carcass layers extending between the two beads and divided between a first and a second family, the first family consisting of carcass layers which are wound, in each bead, from the inside towards the outside of the tire and the second family consisting of carcass layers extending, in each bead, from the outside towards the inside of the tire.

The composition of the tread of the aircraft tires according to embodiments of the invention comprises a first diene elastomer which comprises ethylene units and diene units comprising a carbon-carbon double bond, which units are distributed randomly within the first diene elastomer, the ethylene units representing at least 50 mol % of the combined monomer units of the first diene elastomer.

According to a preferred embodiment of the invention, the first diene elastomer comprises the following units UA, UB, UC and UD, which units UA, UB, UC and UD are randomly distributed within the first diene elastomer,

UA) —CH₂—CH₂— according to a molar percentage of m %

UB) according to a molar percentage of n %

UC)

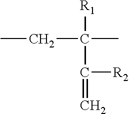

according to a molar percentage of o %

UD)

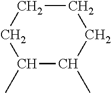

according to a molar percentage of p %
R₁ and R₂, which are identical or different, denoting a hydrogen atom, a methyl radical or a phenyl radical which is unsubstituted or substituted in the ortho, meta or para position by a methyl radical
m≧50
0<o+p≦25
n+o>0
m, n, o and p being numbers ranging from 0 to 100
the respective molar percentages of m, n, o and p being calculated on the basis of the sum of m+n+o+p, which is equal to 100.

According to a specific embodiment of the invention, the first diene elastomer contains units UE distributed randomly within the first diene elastomer:

UE)

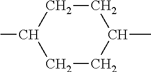

according to a molar percentage of q %
o+p+q≧10
q≧0
the respective molar percentages of m, n, o, p and q being calculated on the basis of the sum of m+n+o+p+q, which is equal to 100.

Whereas the subunit of the unit UD forms a divalent hydrocarbon ring comprising 6 carbon atoms of 1,2-cyclohexane type, the subunit of the unit UE forms a divalent hydrocarbon ring comprising 6 carbon atoms of 1,4-cyclohexane type.

According to another embodiment of the invention, the first diene elastomer contains units UF distributed randomly within the first diene elastomer,

UF)

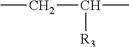

according to a molar percentage of r %
R₃ denoting an alkyl radical having from 1 to 4 carbon atoms or an aryl radical
0≦r≦25, preferably 0≦r≦10
the respective molar percentages of m, n, o, p and r being calculated on the basis of the sum of m+n+o+p+r, which is equal to 100.

According to this specific embodiment of the invention, the first diene elastomer can comprise q % of units UE distributed randomly within the first diene elastomer, in which case the respective molar percentages of m, n, o, p, q and r are calculated on the basis of the sum of m+n+o+p+q+r, which is equal to 100.

It is understood that the first diene elastomer can consist of a mixture of elastomers which contain the units UA, UB, UC, UD, UE and UF according to the respective molar percentages m, n, o, p, q and r as defined above and which differ from one another in their macrostructure or their microstructure, in particular in the respective molar contents of the units UA, UB, UC, UD, UE and UF.

According to any one of the embodiments of the invention, the first diene elastomer preferably does not contain a unit UF.

According to one embodiment of the invention, at least one of the two molar percentages p and q is preferably different from 0. In other words, the first diene elastomer preferably contains at least one of the subunits which are a divalent hydrocarbon ring comprising 6 carbon atoms of 1,2-cyclohexane type and a divalent hydrocarbon ring comprising 6 carbon atoms of 1,4-cyclohexane type. More preferably, p is strictly greater than 0.

According to one embodiment of the invention, the first diene elastomer exhibits at least one and preferably all of the following criteria:
m≧65
n+o+p+q≧15, more preferably 20
10≧p+q≧2
1≧n/(o+p+q)
when q is non-zero, 20≧p/q≧1

According to another preferred embodiment of the invention, the first diene elastomer contains, as monomer units, only the units UA, UB, UC, UD and UE according to their respective molar percentages m, n, o, p and q, preferably all different from 0.

According to another preferred embodiment of the invention, the first diene elastomer contains, as monomer units, only the units UA, UB, UC and UD according to their respective molar percentages m, n, o and p, preferably all different from 0.

According to any one of the embodiments of the invention, the units UB present in the polymer in accordance with embodiments of the invention preferably have the trans configuration represented by the following formula:

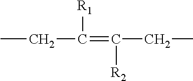

According to any one of the embodiments of the invention, the first diene elastomer preferably exhibits a number-average molar mass (Mn) of at least 60 000 g/mol and of at most 1 500 000 g/mol. The starting diene polymer useful for the requirements of embodiments of the invention preferably exhibits a polydispersity index PI, equal to Mw/Mn (Mw being the weight-average molar mass), of between 1.20 and 3.00. The Mn, Mw and PI values are measured according to the method described in section 11.1.

The first diene elastomer can be obtained according to different methods of synthesis known to a person skilled in the art, in particular as a function of the targeted values of m, n, o, p, q and r. Generally, the first diene elastomer can be prepared by copolymerization of at least one conjugated diene monomer and of ethylene and according to known methods of synthesis, in particular in the presence of a catalytic system comprising a metallocene complex. In this connection, mention may be made of the catalytic systems based on metallocene complexes, which catalytic systems are described in the documents EP 1 092 731 A1, EP 1 554 321 A1, EP 1 656 400 A1, EP 1 829 901 A1, EP 1 954 705 A1 and EP 1 957 506 A1 on behalf of the Applicant Companies.

A conjugated diene having from 4 to 12 carbon atoms is suitable in particular as conjugated diene monomer. Mention may be made of 1,3-butadiene, 2-methyl-1,3-butadiene, 2,3-dimethyl-1,3-butadiene, an aryl-1,3-butadiene or 1,3-pentadiene. According to a preferred aspect, the diene monomer is 1,3-butadiene or 2-methyl-1,3-butadiene, more preferably 1,3-butadiene, in which case R₁ and R₂ each represent a hydrogen.

Thus, according to some of these methods of synthesis, the first diene elastomer can be obtained by copolymerization of at least one conjugated diene monomer and of ethylene, in the presence of a catalytic system comprising a lanthanide metallocene complex with ansa ligands of fluorenyl type. In this connection, mention may be made of the metallocene complexes described in the documents EP 1 092 731 A1, EP 1 554 321 A1 and EP 1 954 705 A1.

The first diene elastomer which contains UF units according to a specific embodiment of the invention can be obtained by copolymerization of at least one conjugated diene monomer and of two olefins, such as ethylene and an α-olefin, in the presence of a catalytic system comprising a lanthanide metallocene complex with ligands of ansa cyclopentadienyl-fluorenyl type. For example, an α-olefin having from 3 to 18 carbon atoms, advantageously having from 3 to 6 carbon atoms, is suitable as α-olefin monomer. Mention may be made of propylene, butene, pentene, hexene or a mixture of these compounds. Mention may also be made, as termonomer used in combination with at least one conjugated diene monomer and ethylene, of a styrene derivative. The catalytic systems based on metallocene complexes can be those described in the documents EP 1 092 731 A1, EP 1 656 400 A1, EP 1 829 901 A1 and EP 1 957 506 A1 on behalf of the Applicant Companies.

The first diene elastomer can be prepared in accordance with the abovementioned documents by adjusting the polymerization conditions by means known to a person skilled in the art, so as to achieve number-average molar mass (Mn) values of at least 60 000 g/mol. By way of illustration, the polymerization time may be significantly increased so that the monomer conversion is greater, thereby leading to molar masses of at least 60 000 g/mol being obtained. By way of illustration, during the preparation of the catalytic systems according to the abovementioned documents, the stoichiometry of the alkylating agent with respect to the metallocene complex(es) is reduced, so as to reduce chain transfer reactions and to make it possible to obtain molar masses of at least 60 000 g/mol.

According to a first alternative form of the invention, the rubber composition additionally comprises a second elastomer, preferably a diene elastomer, that is to say an elastomer comprising diene monomer units. According to any one of the embodiments of the first alternative form of the invention, the content of the second elastomer is preferably less than 50 phr.

The second elastomer can be an “essentially unsaturated” or “essentially saturated” diene elastomer. “Essentially unsaturated” is understood to mean generally a diene elastomer resulting at least in part from conjugated diene monomers having a content of subunits or units of diene origin (conjugated dienes) which is greater than 15% (mol %), which units of diene origin comprise a carbon-carbon double bond; thus it is for this reason that diene elastomers such as butyl rubbers or copolymers of dienes and α-olefins of EPDM type do not come within the preceding definition and can in particular be described as “essentially saturated” diene elastomers (low or very low content, always less than 15%, of subunits of diene origin). In the category of “essentially unsaturated” diene elastomers, a “highly unsaturated” diene elastomer is understood in particular to mean a diene elastomer having a content of subunits of diene origin (conjugated dienes) which is greater than 50%.

Given these definitions, the second diene elastomer capable of being used in the compositions in accordance with embodiments of the invention can be:

(a)—any homopolymer of a conjugated diene monomer, in particular any homopolymer obtained by polymerization of a conjugated diene monomer having from 4 to 12 carbon atoms;

(b)—any copolymer obtained by copolymerization of one or more conjugated dienes with one another or with one or more vinylaromatic compounds having from 8 to 20 carbon atoms;

(c)—a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene.

The second elastomer is preferably a highly unsaturated diene elastomer selected from the group consisting of polybutadienes, polyisoprenes, butadiene copolymers, isoprene copolymers and the mixtures of these elastomers, or else a ternary copolymer obtained by copolymerization of ethylene and of an α-olefin having from 3 to 6 carbon atoms with a non-conjugated diene monomer having from 6 to 12 carbon atoms, in particular an EPDM.

According to a second alternative form of the invention, the first diene elastomer is the only elastomer of the rubber composition.

The reinforcing filler, known for its abilities to reinforce a rubber composition which can be used for the manufacture of tires, can be a carbon black, a reinforcing inorganic filler, such as silica, with which is combined, in a known way, a coupling agent, or also a mixture of these two types of filler.

Such a reinforcing filler typically consists of nanoparticles, the (weight-)average size of which is less than a micrometre, generally less than 500 nm, usually between 20 and 200 nm, in particular and more preferably between 20 and 150 nm.

The carbon black exhibits a BET specific surface preferably of at least 90 m²/g, more preferably of at least 100 m²/g. The blacks conventionally used in tires or their treads (“tire-grade” blacks) are suitable as such. Mention will more particularly be made, among the latter, of the reinforcing carbon blacks of the 100, 200 or 300 series (ASTM grade), such as, for example, the N115, N134, N234 or N375 blacks. The carbon blacks can be used in the isolated state, as available commercially, or in any other form, for example as support for some of the rubber additives used. The BET specific surface of the carbon blacks is measured according to Standard D6556-10 [multipoint (at a minimum 5 points) method—gas: nitrogen—relative pressure p/po range: 0.1 to 0.3].

According to one embodiment of the invention, the reinforcing filler also comprises a reinforcing inorganic filler. “Reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing, by itself alone, without means other than an intermediate coupling agent, a rubber composition intended for the manufacture of pneumatic tires, in other words capable of replacing, in its reinforcing role, a conventional tire-grade carbon black; such a filler is generally characterized, in a known way, by the presence of hydroxyl (—OH) groups at its surface.

Mineral fillers of the siliceous type, preferably silica (SiO₂), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g and in particular between 60 and 300 m²/g.

The physical state in which the reinforcing inorganic filler is provided is unimportant, whether it is in the form of a powder, microbeads, granules or also beads. Of course, reinforcing inorganic filler is also understood to mean mixtures of different reinforcing inorganic fillers, in particular of highly dispersible silicas as described above.

In the present account, as regards the silica, the BET specific surface is determined in a known way by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method—gas: nitrogen—degassing: 1 hour at 160° C.—relative pressure p/po range: 0.05 to 0.17). The CTAB specific surface is the external surface determined according to French Standard NF T 45-007 of November 1987 (method B).

In order to couple the reinforcing inorganic filler to the diene elastomer, use is made, in a well-known way, of an at least bifunctional coupling agent (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

Particularly suitable, without the definition below being limiting, are silane polysulphides corresponding to the following general formula (I):

Z-A-Sₓ-A-Z, in which: (I)
x is an integer from 2 to 8 (preferably from 2 to 5);
the A symbols, which are identical or different, represent a divalent hydrocarbon radical (preferably a C₁-C₁₈ alkylene group or a C₆-C₁₂ arylene group, more particularly a C₁-C₁₀, in particular C₁-C₄, alkylene, especially propylene);
the Z symbols, which are identical or different, correspond to one of the three formulae below:

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂.

Mention will be made, as examples of other organosilanes, for example, of the silanes bearing at least one thiol (—SH) functional group (referred to as mercaptosilanes) and/or at least one masked thiol functional group, such as described, for example, in patents or patent applications U.S. Pat. No. 6,849,754, WO 99/09036, WO 2006/023815, WO 2007/098080, WO 2010/072685 and WO 2008/055986.

The content of coupling agent is advantageously less than 12 phr, it being understood that it is generally desirable to use as little as possible of it. Typically, the content of coupling agent represents from 0.5% to 15% by weight, with respect to the amount of inorganic filler. Its content is preferably between 0.5 and 9 phr, more preferably within a range extending from 3 to 9 phr. This content is easily adjusted by a person skilled in the art depending on the content of inorganic filler used in the composition.

According to a preferred embodiment of the invention, the reinforcing filler is formed to 100% by weight of a carbon black.

According to another embodiment of the invention, the content of reinforcing filler is within a range extending from 20 to 70 phr, preferably from 25 to 50 phr. These ranges of content of reinforcing filler can be applied to any one of the embodiments of the invention.

The crosslinking system can be based either on sulphur, on the one hand, or on sulphur donors and/or on peroxide and/or on bismaleimides, on the other hand. The crosslinking system is preferably a vulcanization system, that is to say a system based on sulphur (or on a sulphur-donating agent) and on a primary vulcanization accelerator. Additional to this base vulcanization system are various known secondary vulcanization accelerators or vulcanization activators, such as zinc oxide, stearic acid or equivalent compounds, or guanidine derivatives (in particular diphenylguanidine), or else known vulcanization retarders, which are incorporated during the first non-productive phase and/or during the productive phase, as described subsequently.

The sulphur is used at a preferred content of between 0.5 and 12 phr, in particular between 1 and 10 phr. The primary vulcanization accelerator is used at a preferred content of between 0.5 and 10 phr, more preferably of between 0.5 and 5.0 phr.

The rubber composition can also comprise all or a portion of the usual additives customarily used in elastomer compositions intended to constitute treads, such as, for example, plasticizers, pigments, protective agents, such as antiozone waxes, chemical antiozonants or antioxidants, or antifatigue agents.

According to a preferred embodiment of the invention, the rubber composition contains from 0 to 20 phr of a liquid plasticizer; preferably, it is devoid of any liquid plasticizer.

A plasticizer is regarded as being liquid when, at 23° C., it has the ability to eventually assume the shape of its container, this definition being given in contrast to plasticizing resins, which are by nature solids at ambient temperature. Mention may be made, as liquid plasticizer, of vegetable oils, mineral oils, ether, ester, phosphate or sulphonate plasticizers, and their mixtures.

The rubber composition according to embodiments of the invention can be manufactured in appropriate mixers, using two successive phases of preparation according to a general procedure well known to a person skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically below 120° C., for example between 60° C. and 100° C., during which finishing phase the chemical crosslinking agent, in particular the vulcanization system, is incorporated.

The rubber composition in accordance with embodiments of the invention can be either in the raw state (before crosslinking or vulcanization) or in the cured state (after crosslinking or vulcanization) and can be a semi-finished product which can be used in a tire, in particular in a tire tread.

The abovementioned characteristics of embodiments of the present invention, and also others, will be better understood on reading the following description of several implementational examples of the invention, given by way of illustration and without limitation.

### II. IMPLEMENTATIONAL EXAMPLES OF THE INVENTION

### II.1-Measurements and Tests Used:

### II.1-a) Size Exclusion Chromatography

Size exclusion chromatography (SEC) is used. SEC makes it possible to separate macromolecules in solution according to their size through columns filled with a porous gel. The macromolecules are separated according to their hydrodynamic volume, the bulkiest being eluted first. Without being an absolute method, SEC makes it possible to comprehend the distribution of the molar masses of a polymer. The various number-average molar masses (Mn) and weight-average molar masses (Mw) can be determined from commercial standards and the polydispersity index (PI=Mw/Mn) can be calculated via a “Moore” calibration.

Preparation of the Polymer:

There is no specific treatment of the polymer sample before analysis. The latter is simply dissolved, in tetrahydrofuran+1 vol % of diisopropylamine+1 vol % of triethylamine+1 vol % of distilled water or in chloroform, at a concentration of approximately 1 g/l. The solution is then filtered through a filter with a porosity of 0.45 μm before injection.

SEC Analysis:

The apparatus used is a “Waters Alliance” chromatograph. The elution solvent is tetrahydrofuran+1 vol % of diisopropylamine+1 vol % of triethylamine or chloroform, according to the solvent used for the dissolution of the polymer. The flow rate is 0.7 ml/min, the temperature of the system is 35° C. and the analytical time is 90 min. A set of four Waters columns in series, with commercial names “Styragel HMW7”, “Styragel HMW6E” and two “Styragel HT6E”, is used.

The volume of the solution of the polymer sample injected is 100 μl. The detector is a “Waters 2410” differential refractometer and the software for making use of the chromatographic data is the “Waters Empower” system.

The calculated average molar masses are relative to a calibration curve produced from PSS Ready Cal-Kit commercial polystyrene standards.

### II.1-b) Loss in Weight

This test makes it possible to determine the loss in weight of a sample of aircraft tire tread composition when it is subjected to an abrasion test on a high-speed abrasion tester. The high-speed abrasion test is carried out according to the principle described in the paper by S. K. Clark, “Touchdown dynamics”, Precision Measurement Company, Ann Arbor, Mich., NASA, Langley Research Center, Computational Modeling of Tires, pages 9-19, published in August 1995. The tread material rubs over a surface, such as a Norton Vulcan A30S-BF42 disc. The linear speed during contact is 70 m/s with a mean contact pressure of 15 to 20 bar. The devices is designed to rub until exhausting of a the energy from 10 to 20 MJ/m² of contact surface.

The components of the constant-energy tribometry device according to the abovementioned paper by S. K. Clark are a motor, a clutch, a rotating plate and a sample holder.

The performance is evaluated on the basis of the loss in weight according to the following formula: Loss in weight performance=loss in weight control/loss in weight sample. The results are expressed in base 100. A performance for the sample of greater than 100 is regarded as better than the control.

### II.1-c) Rheometry

The measurements are carried out at 150° C. with an oscillating disc rheometer, according to Standard DIN 53529—part 3 (June 1983). The change in the rheometric torque ΔTorque (in dN.m) as a function of time describes the change in the stiffening of the composition as a result of the vulcanization reaction. The measurements are processed according to Standard DIN 53529—Part 2 (March 1983): T₀ is the induction period, that is to say the time necessary for the start of the vulcanization reaction; Tₐ (for example T₉₉) is the time necessary to achieve a conversion of a %, that is to say a % (for example 99%) of the difference between the minimum and maximum torques. The conversion rate constant, denoted K (expressed in min⁻¹), which is first order, calculated between 30% and 80% conversion, which makes it possible to assess the vulcanization kinetics, is also measured.

### II.2-Preparation of the Compositions:

The compositions, in the case in point C1 and T1, the formulations of which in phr appear in Table I, are prepared in the following way:

The diene elastomers, the reinforcing filler and also the various other ingredients, with the exception of the vulcanization system, are successively introduced into an internal mixer (final degree of filling: approximately 70% by volume), the initial vessel temperature of which is approximately 80° C. Thermomechanical working (non-productive phase) is then carried out in one stage, which lasts in total approximately from 3 to 4 min, until a maximum “dropping” temperature of 165° C. is reached. The mixture thus obtained is recovered and cooled and then sulphur and an accelerator of sulphenamide type are incorporated on a mixer (homofinisher) at 70° C., everything being mixed (productive phase) for an appropriate time (for example approximately ten minutes).

The compositions thus obtained are subsequently calendered, either in the form of plaques (thickness of 2 to 3 mm) or of thin sheets of rubber, for the measurement of their physical or mechanical properties, or extruded in the form of an aircraft tire tread, and are then vulcanized.

The compositions C1 and T1 are identical, apart from the nature of the elastomer and the sulphur content. The composition C1, which contains the elastomer E1, is intended to be used as aircraft tire tread in accordance with embodiments of the invention; the composition T1, which contains natural rubber, is a conventional composition used as aircraft tire tread.

The elastomer E1 is synthesized by copolymerization of ethylene and 1,3-butadiene comprising 71 mol % of ethylene unit, the remainder to 100% consisting of the 1,3-butadiene units, which are distributed in the form of the units UA, UB, UC and UD according to the molar percentages given in Table II. It is prepared according to a polymerization process in accordance with Example 4-2 of Patent EP 1 954 705 B1 on behalf of the Applicant Companies. The polymerization time was adjusted so as to obtain a molar mass Mn=153 000 g/mol with a polydispersity index equal to 1.9.

The difference in the chemical structure of the elastomers C1 and T1 brings about a behaviour of the compositions C1 and T1 with regard to the vulcanization which is also different, which has resulted in the sulphur content being adjusted according to the composition to be vulcanized in order to obtain faster curing kinetics and a curing time acceptable to a person skilled in the art. The rate constants K and the T₀, T₉₀ and T₉₉ values of the compositions C1 and T1 appear in Table I.

### II.3-Properties of the Rubber Compositions in the Cured State:

The result of this test, which appears in Table I, shows that the loss in weight performance of the composition C1 is doubled with respect to the control T1 in a high-speed abrasion test, recognised as a specific laboratory descriptor of the extreme conditions of ground landing. Thus, the aircraft tire in accordance with embodiments of the invention which has the composition C1 for tread is twice as effective in withstanding the extreme conditions of landing than the aircraft tire, the tread of which consists of a conventionally used composition based on natural rubber.

To sum up, the tire in accordance with embodiments of the invention exhibits a performance on landing which is greatly improved, in particular with regard to the wear resistance at very high speeds.

TABLE I

| Composition | T1 | C1 |
|---|---|---|
| NR (1) | 100 | — |
| Elastomer E1 | — | 100 |
| Carbon black (2) | 30 | 30 |
| Antioxidant (3) | 1.5 | 1.5 |
| Stearic acid (4) | 2.5 | 2.5 |
| Zinc oxide (5) | 3 | 3 |
| Accelerator (6) | 2.0 | 2.0 |
| Sulphur | 0.8 | 1.5 |
| Loss in weight performance (%) | 100 | 180 |
| Rheometry | | |
| K (min⁻¹) | 0.41 | 0.18 |
| T₀ (min) | 6 | 9 |
| T₉₀ (min) | 12 | 22 |
| T₉₉ (min) | 17 | 34 |

(1) Natural rubber
(2) N234 according to Standard ASTM D-1765
(3) N-(1,3-Dimethylbutyl)-N-phenyl-para-phenylenediamine, Santoflex 6-PPD from Flexsys
(4) Stearin, Pristerene 4931 from Uniqema
(5) Zinc oxide of industrial grade from Umicore
(6) N-Cyclohexyl-2-benzothiazolesulphenamide, Santocure CBS from Flexsys

TABLE II

| | |
|---|---|
| Subunit UA | 71 |
| Subunit UB | 8 |
| Subunit UC | 14 |
| Subunit UD | 7 |

TABLE III

| Composition | T1 | C1 |
|---|---|---|
| Loss in weight performance (%) | 100 | 180 |

1. An aircraft tire, the tread of which comprises a rubber composition based on at least one first diene elastomer, a reinforcing filler and a crosslinking system, which first diene elastomer comprises ethylene units and diene units comprising a carbon-carbon double bond, which units are distributed randomly within the first diene elastomer, the ethylene units representing at least 50 mol % of the combined monomer units of the first diene elastomer.

2. A tire according to claim 1, in which the first diene elastomer comprises the following units UA, UB, UC and UD randomly distributed within the first diene elastomer,
UA) —CH₂—CH₂— according to a molar percentage of m %
UB) according to a molar percentage of n %
UC) 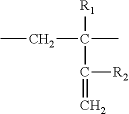
according to a molar percentage of o %
UD) 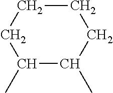
according to a molar percentage of p %
R₁ and R₂, which are identical or different, denoting a hydrogen atom, a methyl radical or a phenyl radical which is unsubstituted or substituted in the ortho, meta or para position by a methyl radical
m≧50
0<o+p≦25
n+o>0
m, n, o and p being numbers ranging from 0 to 100
the respective molar percentages of m, n, o and p being calculated on the basis of the sum of m+n+o+p, which is equal to 100.

3. A tire according to claim 2, in which the first diene elastomer contains units UE randomly distributed within the first diene elastomer,
UE) 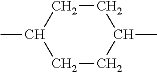
according to a molar percentage of q %
o+p+q≧10
q≧0
the respective molar percentages of m, n, o, p and q being calculated on the basis of the sum of m+n+o+p+q, which is equal to 100.

4. A tire according to claim 2, in which the first diene elastomer contains units UF randomly distributed within the first diene elastomer,
UF) 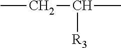
according to a molar percentage of r %
R₃ denoting an alkyl radical having from 1 to 4 carbon atoms or an aryl radical
0≦r≦25
the respective molar percentages of m, n, o, p, q and r being calculated on the basis of the sum of m+n+o+p+q+r, which is equal to 100.

5. A tire according to claim 4, in which r is equal to 0.

6. A tire according to claim 2, in which at least one of the two molar percentages p and q is different from 0.

7. A tire according to claim 2, in which p is strictly greater than 0.

8. A tire according to claim 2, in which the first diene elastomer exhibits at least one of the following criteria:
m≧65
n+o+p+q≧15
10≧p+q≧2
1≧n/(o+p+q)
when q is non-zero, 20≧p/q≧1

9. A tire according to claim 3, in which the first diene elastomer contains, as monomer units, only the units UA, UB, UC, UD and UE according to their respective molar percentages m, n, o, p and q.

10. A tire according to claim 2, in which the first diene elastomer contains, as monomer units, only the units UA, UB, UC and UD according to their respective molar percentages m, n, o and p.

11. A tire according to claim 1, in which R₁ and R₂ are identical and denote a hydrogen atom.

12. A tire according to claim 1, in which the rubber composition comprises a second elastomer.

13. A tire according to claim 12, in which the second elastomer is a highly unsaturated diene elastomer selected from the group consisting of polybutadienes, polyisoprenes, butadiene copolymers, isoprene copolymers and the mixtures of these elastomers.

14. A tire according to claim 12, in which the second elastomer is a ternary copolymer obtained by copolymerization of ethylene and of an α-olefin having from 3 to 6 carbon atoms with a non-conjugated diene monomer having from 6 to 12 carbon atoms.

15. A tire according to claim 1, in which the first diene elastomer is the only elastomer of the rubber composition.

16. A tire according to claim 1, in which the reinforcing filler comprises a carbon black.

17. A tire according to claim 16, in which the reinforcing filler is formed to 100% by weight of a carbon black.

18. A tire according to claim 1, in which the reinforcing filler comprises an inorganic filler.

19. A tire according to claim 1, in which the content of reinforcing filler is from 20 to 70 phr.

20. A tire according to claim 1, in which the rubber composition contains from 0 to 20 phr of a liquid plasticizer.

21. A tire according to claim 20, in which the content of liquid plasticizer is equal to 0.
